(19) United States
(12) Patent Application Publication
(10) Pub. No.: US 2012/0047438 A1
(43) Pub. Date: Feb. 23, 2012

(54) CUSTOMIZED SYSTEM AND METHOD FOR WEBSITE USER DATA COLLECTION, ANALYSIS AND REPORTING FOR AN ENTIRE WEBSITE

(76) Inventor: Colin Wahl, Chapel Hill, NC (US)

(21) Appl. No.: 12/860,191

(22) Filed: Aug. 20, 2010

(51) Int. Cl. G06F 3/01; G06F 15/16

(52) U.S. Cl. 715/733

(57) ABSTRACT

The present invention relates in general to web site administration. In particular, the present invention relates to a system and method for collecting information and user reactions to an entire website and reporting to the website owner.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates in general to web site administration. In particular, the present invention relates to a system and method for collecting information and user reactions to an entire website and reporting to the website owner.

2. Description of Related Art

The collection of data about a website is important to may website owners. The collection of the number of users or clicks, the time spent on the website, where the user traveled from, or particular web pages visited, is often collected and available to website users. Not only are there small providers of such service, but ever large advertising giants like Google provide both click data as well as a reporting dashboard. The website owner can utilize the information to improve the website and success of their business based on the traffic information.

While this information is useful, it does not provide information about the website itself. Because the number of visitors or other quantity data may not be the problem and the individual website pages themselves might have problems, a number of attempts to provide information about particular web pages have been developed. For example, in U.S. Pat. No. 7,085,820 to Nickerson issued Aug. 1, 2006, there is described a feedback system for a particular page in a website. It comprises a database containing page-specific user reactions along with a reporting module. Other patents over the years have attempted to maximize page-specific data to the website owner. In U.S. Pat. No. 6,606,581 to Nickerson issued Aug. 12, 2003, there is a page specific reporting system which includes a page-specific icon and software connected with the page-specific to control the feedback and results of the report.

While page specific data is useful to understand the reaction to the particular page, it does not provide the reaction to the entire website as a whole. In addition, what data it provides is modified with difficulty by contacting a service provider and waiting for the changes. The website as a whole is frequently the deciding factor in customers going forward with a purchase or other desired activity and individual pages may not be sufficient to determine if or why a particular site is going well or has problems.

### BRIEF SUMMARY OF THE INVENTION

The present invention relates to a system and method for gathering data on the website as a whole. The invention further allows the user to customize questions in response to feedback and further customization of the website. Further, the information can be collected and observed by access of the server over the internet, or by e-mail or cell phone, giving the user more options than other systems and more accurately analyzing the website as a whole than analyzing a page at a time.

Accordingly, one embodiment of the invention is a system located on a server for use with a website having a plurality of pages accessible on the internet, designed for a website user to report to the website owner their reactions to the website as a whole comprising:
a) a feedback module, accessible from a plurality of icons located on the plurality of website pages by the website user, that asks the user specific questions relating to the website as a whole to capture the user reaction to the entire website and stores the answers to the questions on the server;
b) an analysis module coupled to the feedback module comprising a data module and a reporting module, the data module designed to collect the data from the feedback module and the reporting module designed to take the data from the data module and deliver a report to the website owner; and
c) an editor module coupled to the feedback module, the analysis module and the website icons to be able to modify the feedback module to ask the desired questions of the user and gather the desired information about the website as a whole from the user, modify the reporting module to present the data collected from the data module to present a desired report to the website owner and modify the website icon to a desired icon.

In another aspect of the invention the present invention relates to a method of generating reactions to an entire website having a plurality of pages accessible on the internet by a website user, storing the reactions on a server and reporting them to the website owner comprising:
a) using an editor module on the server, by the website owner, to store on the server a plurality of desired questions relating to reactions to the website as a whole and designed to be answered by the website user;
b) delivering the questions to a feedback module for presentation to the website user;
c) presenting the questions from the feedback module in response to the website user engaging an icon located on at least one of the plurality of website pages;
d) storing the answer to the questions from the website user on the server;
e) generating one or more reports for communication to the website owner which present the stored answers to the questions to the website owner; and
f) delivering the one or more reports to the website owner in response to an inquiry to the system for a report.

### BRIEF DESCRIPTION OF THE DRAWINGS

FIG. 1 is a diagram of the data collection system of the present invention.

FIG. 2 is a diagram of a feedback editor of the present invention.

FIG. 3 is a diagram of data analysis in the present system.

FIG. 4 is a flow chart of a user providing data about a website.

FIG. 5 is an example of a Feedback card.

FIG. 6 is further examples of questions on a feedback card.

FIG. 7 is a thank you card to user.

FIG. 8 is an example of a card editor.

FIGS. 9a and 9b are an example of Dashboard data analysis.

FIG. 10 is a report of all feedback cards received for a web site.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “server” refers to one or more computers that are capable of, or are connected to the internet or the equivalent communication network. “Computer” can mean a dedicated computer used as a server or any computer which can be connected to the internet and has the computing power to accomplish the described invention, including net books, laptops, PC type or Apple type computers, PDAs, and the like, including being able to collect, store, and process data, publish websites, and the like. It may also be more than one computer connected to join together computing and memory power. Supercomputer type computers, while not usually used for this purpose, could if cost effective enough. The server computer will also need to have certain readily available software, as mentioned herein, available on resident memory and also will need certain hardware interface known in the art to access the internet, send e mails, e-mail interface with a GUI and the website owner, and the like.

As used herein, a “website” refers to websites as a whole having a plurality of pages that is accessible on the internet by a website user including a home page, information about the website owner's company, products or services for sale, and other aspects of the website owner's business that the website owner is desirous of presenting to a particular desired website user. The website owner posts the website to accomplish a particular goal with the website user as opposed to particular website pages that have a specific task that is only some subset or the like of the entire website purpose. In general, the present invention is designed to generate a report to the website owner from information gathered from the website user, to determine the success of the overall website in achieving a desired purpose of the website owner. This is done by the website owner generating a series of reaction questions which the answerers from the website user using the feedback card can give the website owner to help determine the effectiveness of the website post. It also allows the website owner to, on the fly, modify the questions asked the website user to fine tune the feedback information without having to utilize outside services or wait for long times while HTML or other programming of the website is accomplished.

As used herein, the term “report” refers to the taking data or other information in the form of the answers to questions on a feedback module and presenting the data to the website user in a functionally useful way. That might mean not only the specific answer to questions but also graphs, charts summaries, totals, and the like, such that the website user can analyze the results in ways other than just reading the answers to each question from each website user. One format could be a Dashboard style report. Other type reports could include spreadsheet type reports which then could be downloaded to the website owner's computer for further observation and analysis.

The report can be delivered to the website owner in a number of ways. For example, the system could have a GUI which allows the website owner to open and review reports. Reports could also be customized with the editor module to present data in the most useful manner possible to the individual website owner, thus customizing the data report. The data could also be delivered by other systems, such as by e-mail, text message, cell phone/PDA type devices, and the like. The system of the present invention could also include modules for delivering the reports or data in those manners for the convenience of the website owner and to be able to access info on the fly while traveling or otherwise away from the regular computer interface with the internet.

As used herein, the phrase “feedback module” refers to resident software on a server computer that is capable of presenting the user over their internet connection while visiting the website of the website owner, the specific questions will give the data about the website user's experience with the website as a whole. That is in particular to capture the reaction of the website user to the website. The format can be a questionnaire, a feedback card, multiple choice questions, numerical ratings of specific items, and the like. Specific examples can be seen in the figure explanations which follow. The feedback module is accessible by the website user by going to one or more pages on a website having a plurality of pages and clicking on an icon placed there by the system. In one embodiment the icon is on all the pages of the website accessible by the website user.

The feedback module, in addition to presenting the questions, also collects the website user's answers to the questions for processing into a report. It can store the answers on a server located database or other resident server memory location. Other embodiments of the feedback module will include the ability to generate a thank you card in response to completing the questions, keeping track of who has answered so one user cannot answer multiple times, generate advertising in response to answers to the questions or the like.

As used herein, the phrase “analysis module” is a collection of a plurality of sub modules. The analysis module is located on the server as resident memory software and is coupled to the feedback module to receive the data, answers to questions, and the like, received by the feedback module. While the data could be stored on the feedback module, it could also be sorted in the analysis module or in both locations, as desired, or for ease of the software speed and efficiency. A data module on the analysis module can hold the data, and also where necessary, comprise other software in resident memory to analyze or to otherwise apply mathematical algorithms, manipulate the data, and the like, and generate the reports desired by the website owner. The reporting module can then take the reports, raw data, or the like and deliver the report to the website owner via GUI, cell phone, e-mail, text message, and the like.

As used herein the phrase “editor module” refers to another resident memory piece of software coupled to the feedback module, the analysis module and the icons for accessing the feedback module. The purpose is to be able to edit these items by the website owner without need to “program” website language to accomplish that task and avoid taking a long time to change questions when fast changes or on the fly changes to the feedback is necessary. It also allows the website owner to customize the feedback module, icon, and report such that it has a look specific to the website and can have the appearance of being designed specifically for the website by use of website owner logos, icons, text, colors, and the like. Specifically, it can then modify the feedback module to ask desired questions of the user, gather desired information about the website from the user, modify the look of the feedback module to the user, modify the reporting module to present the report in a specific way, as well as modify (i.e. choose a selected) icon for use on the website for access to the feedback module.

The present invention system then comprises the combination of the feedback module, analysis module, and editor module as described above in combination. The particular invention may consist of or consist essentially of just these modules however in other embodiments the invention comprises these three modules.

The method of the present invention relates to generating reactions specifically to an entire website (as opposed to particular web pages) where the website has a plurality of pages on the internet. The reactions are from a website user where the system records or stores the reactions on a server and can report the answers to the website owner. Specifically, the process involves utilizing the editor module on the server as described above to store on the server a plurality of desired questions relating to the reactions to the website; these questions are to be answered by the website user. Next, the questions are delivered to the feedback module. This is in order to present the feedback questions to the website user taking the feedback survey (answering questions). Once the website user engages the icon on the website, the questions are presented to the website user from the feedback module. Once the questions are answered, the answers are stored on the server in a database, the data module, or the like. The stored data/answers to the question are then used in generating one or more reports for communication to the website owner and once they are generated they are delivered to the website owner in response to a report inquiry.

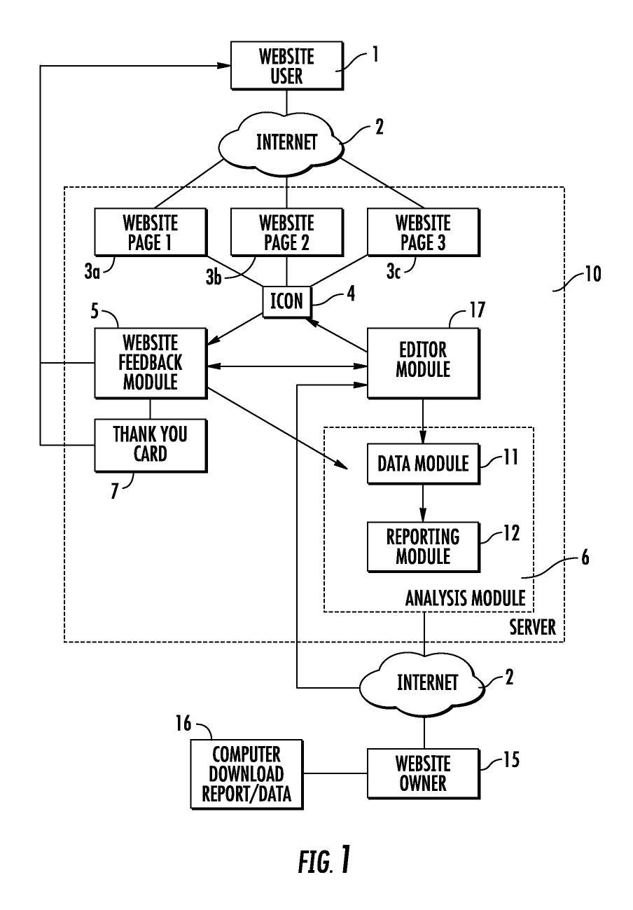

Now referring to the figures. FIG. 1 is a diagram of an embodiment of the system of the present invention. The system is located on server 10. As resident memory for presentation to the internet 2. Website user 1 accesses the internet 2 by any normal means (computer access) for the purposes of accessing a website represented by a plurality of website pages 3a, 3b and 3c. Each of pages 3a, 3b, and 3c have an icon 4 which when engaged by the website user 1 allows the website user 1 to access the website feedback module 5. As noted above the feedback module 5 asks the user 1 a series of questions and the answers to which are recorded on the feedback module 5 or on the analysis module 6.

The feedback module 5 after taking the response to the questions can, in this embodiment, send thank you card 7, an electronic thank you, to the user on their computer. The present invention has an editor module 17. The editor module 17 allows the editing of the icon 4, the feedback module 5, and the analysis module 6, including the data module and reporting module.

The data module 11 in this embodiment, stores the data collected by the feedback module, though optionally, the data module could be in the feedback module instead of the analysis module 6. The data module 11 is normally a database of a desired kind and is stored in resident memory on the server 6 or in a memory device like a static memory, external hard drive, or the like. The reporting module 12 takes the data from the data module 11 and creates reports. The editor module 17 is able to customize the reporting module 12 in such a way that a desired format is utilized for the website owner 15 reviewing the report. For example, data can be view as a list in one embodiment or as a chart in another embodiment. In other embodiments the data can be down loaded to the website owner's 15 computer 16 for off line (off the internet 2) view or storage of the data or reports.

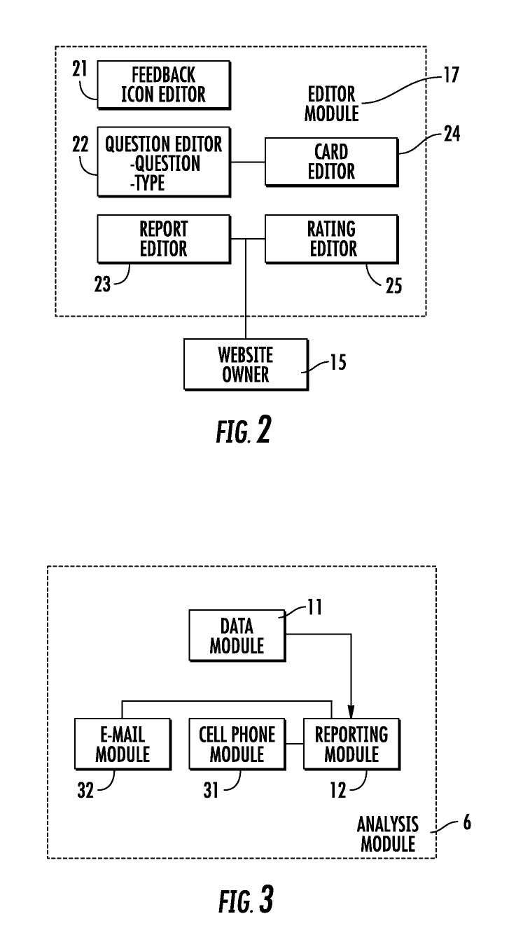

FIG. 2 shows the editor module 17 in more detail. The editor module 17 is capable of editing a number of basic items as well as some optional embodiments. The feedback icon editor 21 allows the user of the system to either use one or more stock icons or to substitute the website owner 15 icon as desired and to place it on a desired plurality of pages. The icon can be placed on all or part of the pages in the website, but in all cases the icon 4 no matter which page it is clicked on takes you to the same feedback module 5 since the feedback is for the entire website, not the individual web page.

The question editor 22 allows the website owner 15 to edit the questions and type of questions being asked of the website user 1 so that a complete picture of the usefulness of the website as a whole can be determined. For example, questions about why the website was visited and if the goals for visiting the website can be asked. In other embodiments the website can be graded, for example, for content, design, and ease of use, or to give particular suggestions for improving the website as a whole.

The report editor 23 allows the taking of data from the data module 11 and preparing a report that can be customized in a manner that allows the user to view the data in one of a number of desired formats. For example, different charts or chart styles, number reporting, time frames, user types, and the like.

A card editor 24 allows the customization of the feedback card the website user 1 gets to see. For example color lines, background, text and the like can be edited. In one embodiment, company logo's can beaded along with company information and the like.

A rating editor 25 allows the customization and editing of ratings of the site or particular features of the website as a whole. Features that appear as ratings can then be formed and added to the website as desired.

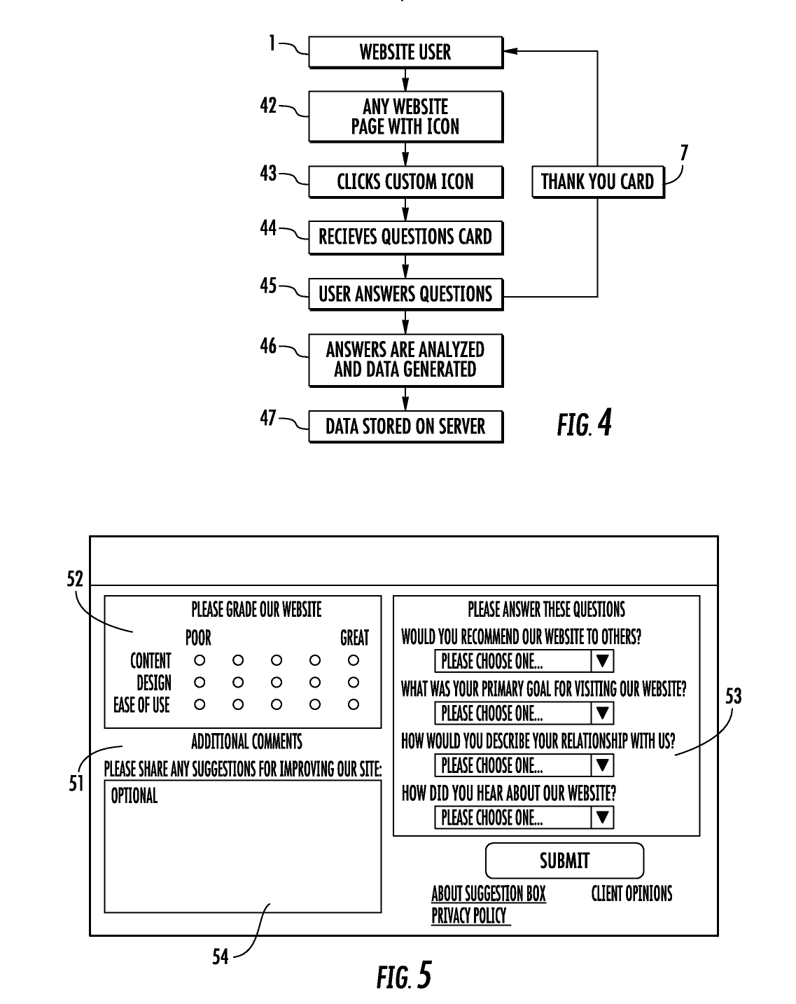

FIG. 3 depicts a more detailed look at the analysis module 6. It includes additional modules; the cell phone module 31 which allows the system to send data from the reporting module 12, or data module 11 to a website owner 15 cell phone over the internet or via text messaging, or other means for communicating with a cell phone. The e-mail module 32 configures the data from the reporting module 12 or the data module 11 and places it in an e-mail for e-mailing the feedback to the website owner 15. The optional modules allow the website owner 15 to not have to rely on just signing on the internet 2 and interface with the server 10 on a computer set up.

FIG. 4 depicts an embodiment of the website user 1 utilizing the system of the present invention. The website user finds a page with an icon on it 42. The website user then clicks on the custom icon 43 which brings up a questionnaire 44. The website user 1 then answers the questions 45. At the conclusion of answering the questions 45, a thank you card 7 is sent to website owner 1. The answers to the questions 45 are analyzed and data generated 46 and then the data is sorted on the server 47.

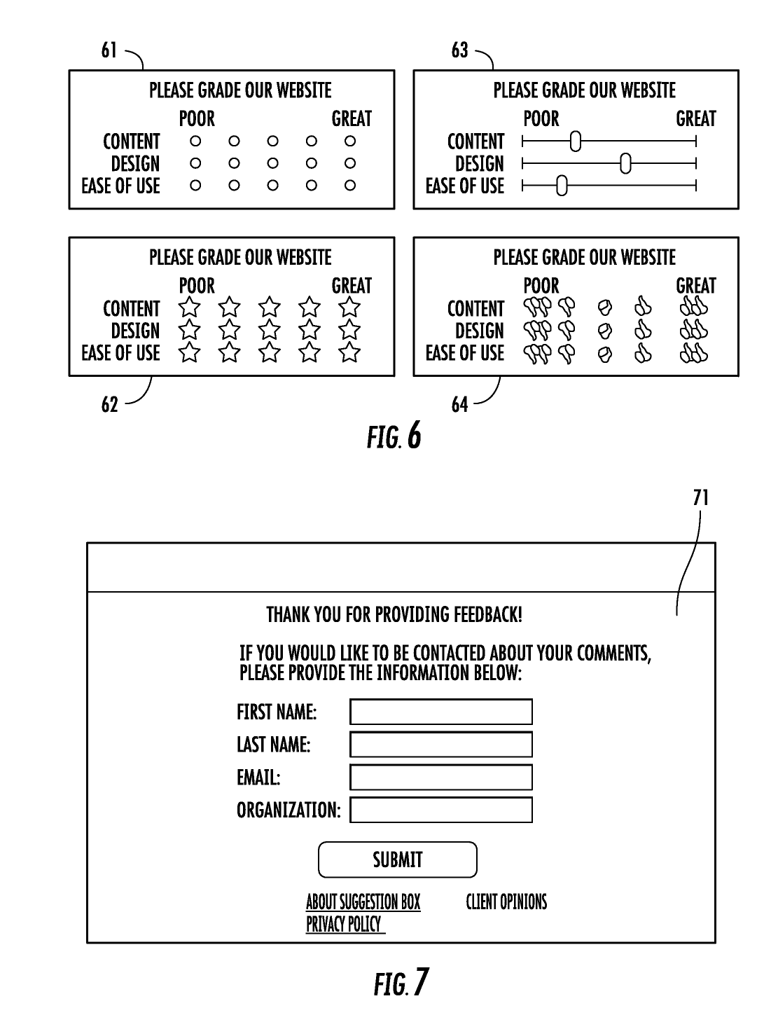

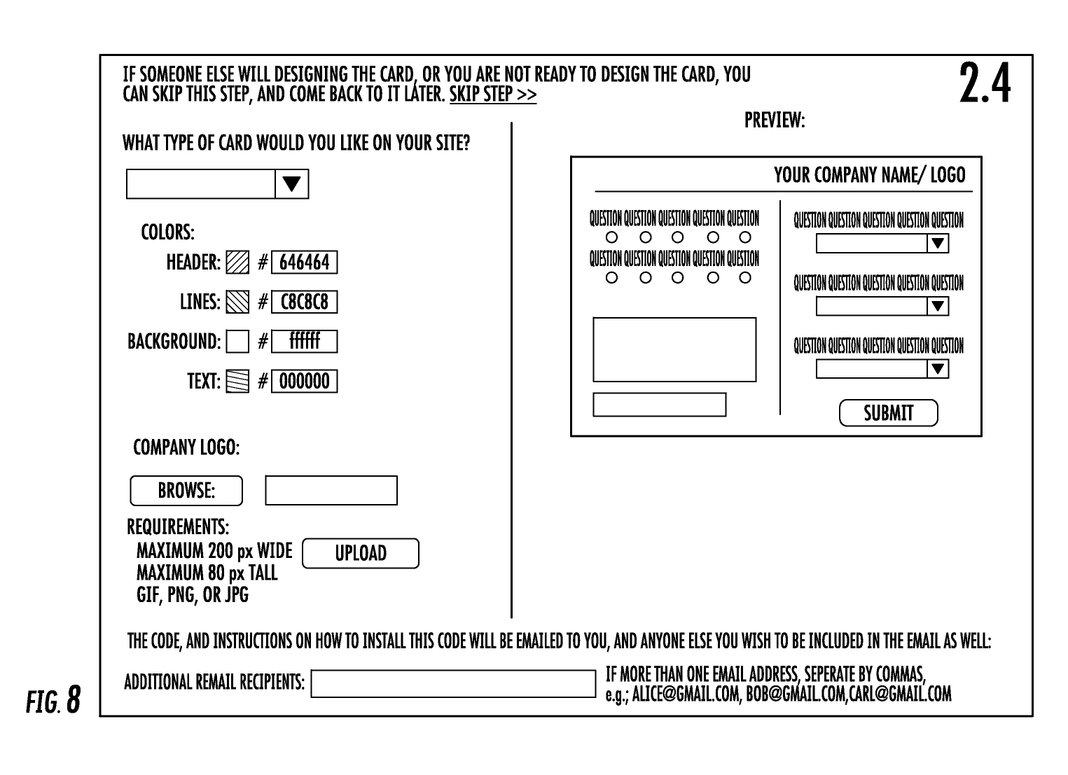

The remaining figures give embodiment examples of particular portions of the system. FIG. 5 shows an embodiment of a feedback card 51 of the present invention. Shown is a grading section 52, a questions section 53 and a comment section 54. FIG. 6 shows various types of grade our website indicators 61-64 that could be selected by an editor and placed on a feedback editor.

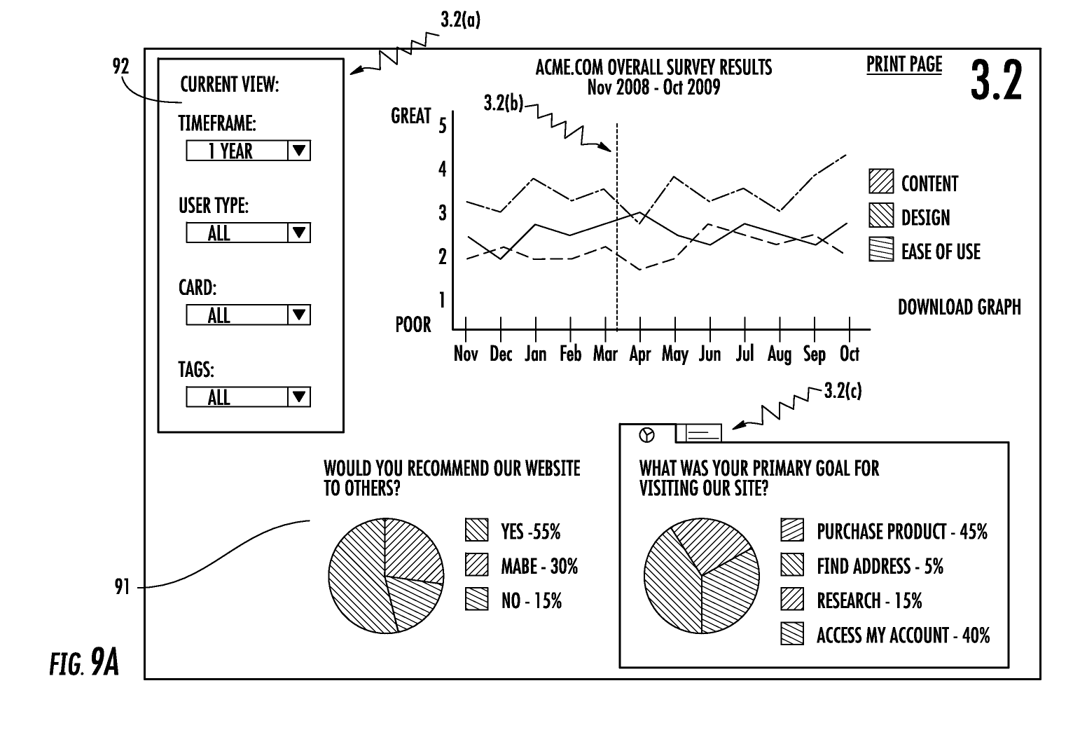

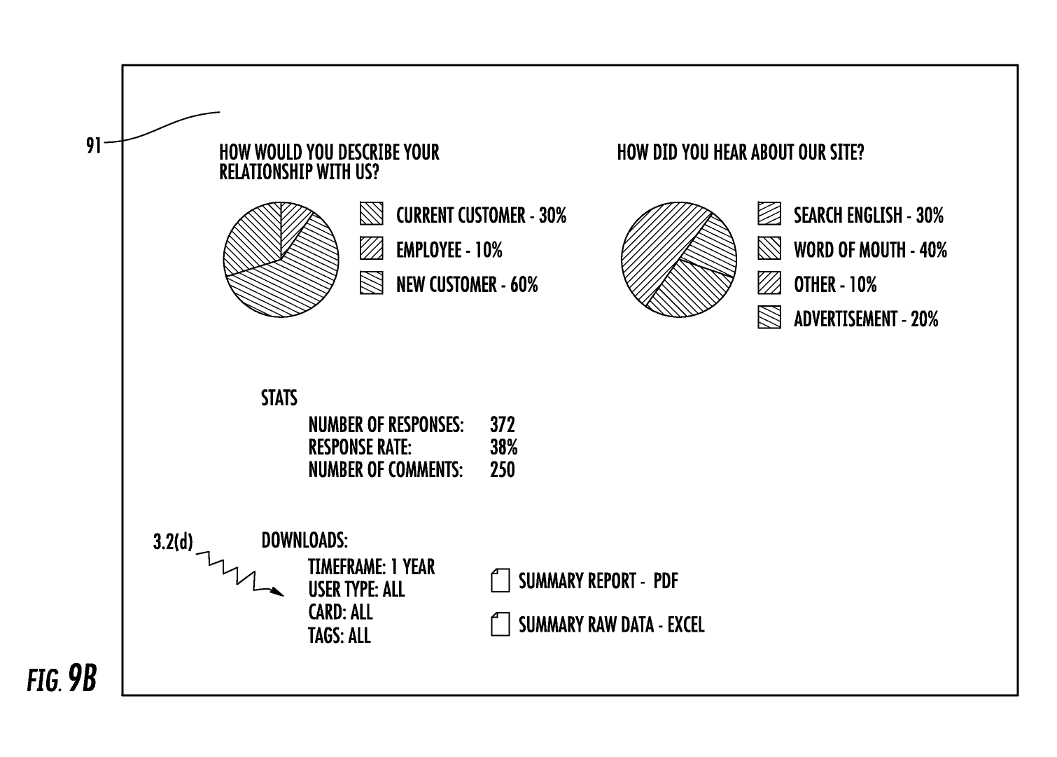

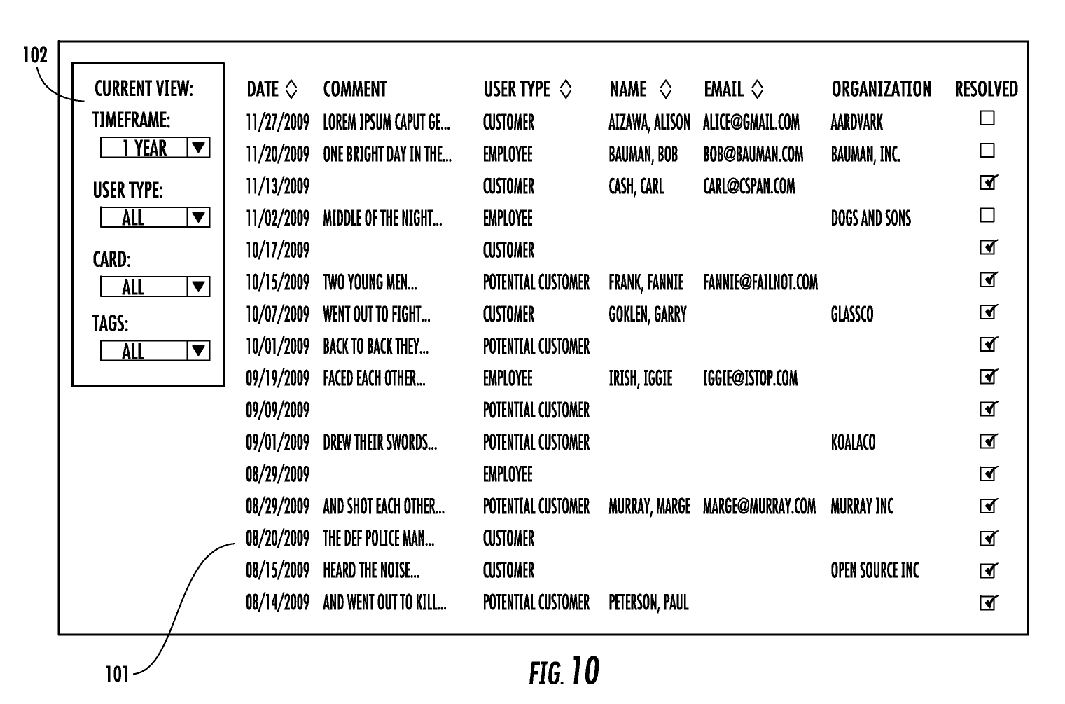

FIG. 7 shows a thank you card 71. It also shows a way to combine a thank you card with a request for more information on the thank you card. FIG. 8 depicts a screen shot of a card editor 81 where the color, logos for the company editing of questions and types of questions and comments can be edited. FIGS. 9a and 9b show data displayed from a data module and report generator 91. The page is from an editor page where the website owner can select various criteria for a current view 92 for viewing of the data 91. Lastly FIG. 10 depicts the report generator where a list of all the website users and their information is displayed in a data base type format 101. This view also has a database editor 102.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system located on a server for use with a website having a plurality of pages accessible on the internet designed for a website user to report to the website owner their reactions to the website as a whole comprising:
a) a feedback module, accessible from a plurality of icons located on the plurality of website pages by the website user, that asks the user specific questions relating to the website as a whole to capture the user reaction to the entire website and stores the answers to the questions on the server;
b) an analysis module coupled to the feedback module comprising a data module and a reporting module, the data module designed to collect the data from the feedback module and the reporting module designed to take the data from the data module and deliver a report to the website owner; and
c) an editor module coupled to the feedback module, the analysis module and the website icons to be able to modify the feedback module to ask the desired questions of the user and gather the desired information about the website as a whole from the user, modify the reporting module to present the data collected from the data module to present a desired report to the website owner and modify the website icon to a desired icon.

2. A system according to claim 1 wherein the analysis module also comprises an e-mail module and a cell phone module for reporting to the website owner.

3. A system according to claim 1 wherein there is a database for storing data on the server.

4. A system according to claim 1 wherein the system generates a thank you card to the website user after completing the questions.

5. A system according to claim 1 wherein it further comprises the ability for the website user to generate comments other than to respond to questions.

6. A method of generating reactions to an entire website having a plurality of pages accessible on the internet by a website user, storing the reactions on a server and reporting them to the website owner comprising:
a) using an editor module on the server, by the website owner, to store on the server a plurality of desired questions relating to reactions to the website as a whole and designed to be answered by the website user;
b) delivering the questions to a feedback module for presentation to the website user;
c) presenting the questions from the feedback module in response to the website user engaging an icon located on at least one of the plurality of website pages;
d) storing the answer to the questions from the website user on the server;
e) generating one or more reports for communication to the website owner which present the stored answers to the questions to the website owner; and
f) delivering the one or more reports to the website owner in response to an inquiry to the system for a report.

7. A method according to claim 6 wherein the questions relate to the content, design or ease of use of the website as a whole.

8. A method according to claim 6 wherein the questions relate to how the website user found the website.

9. A method according to claim 6 wherein the questions relate to the reason why the website user visited the website.

10. A method according to claim 6 wherein the questions relate to determining if the user achieved their goal in visiting the site.
